(19) United States
(12) Patent Application Publication
(10) Pub. No.: US 2025/0045588 A1
(43) Pub. Date: Feb. 6, 2025

(54) LEARNING METHOD, LEARNING DEVICE, AND IMAGE RECOGNITION SYSTEM

(71) Applicant: KABUSHIKI KAISHA TOSHIBA, Tokyo (JP)

(72) Inventors: Atsushi YAGUCHI, Taito Tokyo (JP); Wataru ASANO, Yokohama Kanagawa (JP); Shuhei NITTA, Ota Tokyo (JP); Yukinobu SAKATA, Kawasaki Kanagawa (JP); Akiyuki TANIZAWA, Kawasaki Kanagawa (JP)

(73) Assignee: KABUSHIKI KAISHA TOSHIBA, Tokyo (JP)

(21) Appl. No.: 18/805,495

(22) Filed: Aug. 14, 2024

Related U.S. Application Data
(63) Continuation of application No. 16/286,652, filed on Feb. 27, 2019.

(30) Foreign Application Priority Data
Jul. 4, 2018 (JP) 2018-127517

(51) Int. Cl. G06N 3/082; G06N 3/04

(52) U.S. Cl. CPC G06N 3/082; G06N 3/04

(57) ABSTRACT

According to an embodiment, a learning method of optimizing a neural network, includes updating and specifying. In the updating, each of a plurality of weight coefficients included in the neural network is updated so that an objective function obtained by adding a basic loss function and an L2 regularization term multiplied by a regularization strength is minimized. In the specifying, an inactive node and an inactive channel are specified among a plurality of nodes and a plurality of channels included in the neural network.

### CROSS-REFERENCE TO RELATED APPLICATIONS

This application is based upon and claims the benefit of priority from Japanese Patent Application No. 2018-127517, filed on Jul. 4, 2018; the entire contents of which are incorporated herein by reference.

### FIELD

Embodiments described herein relate generally to a learning method, a learning device, and an image recognition system.

### BACKGROUND

In recent years, a neural network has been applied to various fields such as image recognition, machine translation, and voice recognition. Such a neural network is required to increase a configuration in order to achieve high performance. However, in order to cause it to operate directly in an edge system or the like, it is necessary to reduce the size of the neural network as much as possible.

### BRIEF DESCRIPTION OF THE DRAWINGS

FIG. 1 is a diagram illustrating a configuration of a learning device according to a first embodiment;

FIG. 2 is a diagram illustrating a process flow of the learning device according to the first embodiment;

FIG. 3 is a diagram illustrating a configuration of a learning device according to a second embodiment;

FIG. 4 is a diagram illustrating a configuration of a learning device according to a third embodiment;

FIG. 5 is a diagram illustrating a process flow of the learning device according to the third embodiment;

FIG. 6 is a diagram illustrating a configuration of an automatic driving system according to a fourth embodiment;

FIG. 7 is a diagram illustrating a weight coefficient of a convolution layer in a neural network;

FIG. 8 is a diagram illustrating a weight coefficient of a fully connected layer in a neural network;

FIG. 9 is a diagram illustrating an optimization algorithm of a weight coefficient by AdaMax;

FIG. 10 is a diagram illustrating an optimization algorithm of a weight coefficient by Nadam;

FIG. 11 is a diagram illustrating an optimization algorithm of a weight coefficient by Adam-HD;

FIG. 12 is a diagram illustrating basic conditions in a first experiment example;

FIG. 13 is a diagram illustrating basic conditions in a second experimental example;

FIG. 14 is a diagram illustrating a validation accuracy for a sparse rate; and

FIG. 15 is a diagram illustrating an example of a hardware configuration of a learning device according to an embodiment.

### DETAILED DESCRIPTION

According to an embodiment, a learning method of optimizing a neural network, includes updating and specifying. In the updating, each of a plurality of weight coefficients included in the neural network is updated so that an objective function obtained by adding a basic loss function and an L2 regularization term multiplied by a regularization strength is minimized. In the specifying, an inactive node and an inactive channel are specified among a plurality of nodes and a plurality of channels included in the neural network.

Embodiments will be described in detail with reference to the appended drawings. A learning device 10 according to the present embodiment updates a plurality of weight coefficients included in a neural network 20 through a learning process. Accordingly, the learning device 10 can optimize the neural network 20 for a predetermined application and reduce the size of the neural network 20.

### First Embodiment

First, a first embodiment will be described.

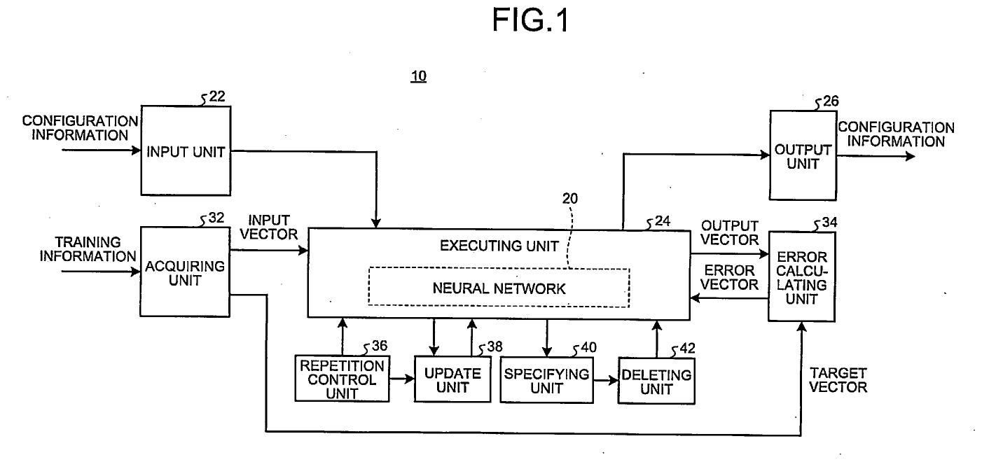

FIG. 1 is a diagram illustrating a configuration of a learning device 10 according to a first embodiment. The learning device 10 includes an input unit 22, an executing unit 24, an output unit 26, an acquiring unit 32, an error calculating unit 34, a repetition control unit 36, an update unit 38, a specifying unit 40, and a deleting unit 42.

Prior to the learning process, the input unit 22 acquires configuration information for realizing the neural network 20 before optimization from an external device or the like.

The executing unit 24 stores the configuration information acquired by the input unit 22 therein. Then, when data is given, the executing unit 24 executes an operation process according to the stored configuration information. Accordingly, the executing unit 24 can function as the neural network 20.

A weight coefficient included in the configuration information stored in the executing unit 24 is changed by the update unit 38 during the learning process. Further, information related to a node and a channel included in the configuration information stored in the executing unit 24 may be deleted by the deleting unit 42.

The output unit 26 transmits the configuration information stored in the executing unit 24 to the external device after the learning process ends. Accordingly, the output unit 26 can cause the external device to realize the optimized neural network 20.

The acquiring unit 32 acquires a plurality of pieces of training information for optimizing the neural network 20 for a predetermined application. Each of a plurality of pieces of training information includes an input vector and a target vector serving as a target of an output vector. The acquiring unit 32 assigns the input vector included in each piece of training information to the neural network 20 realized by the executing unit 24. Further, the acquiring unit 32 assigns the target vector included in each piece of training information to the error calculating unit 34.

The error calculating unit 34 generates an error vector on the basis of the output vector, the target vector, and a basic loss function. Specifically, the neural network 20 outputs the output vector from the output layer when the input vector included in the training information is given to an input layer. The error calculating unit 34 acquires the output vector output from an output layer of the neural network 20. Further, the error calculating unit 34 acquires the target vector included in the training information. The error calculating unit 34 calculates an error vector indicating an error between the output vector and the target vector. For example, the error calculating unit 34 assigns an output vector and a target vector to a predetermined basic loss function and calculates an error vector. The error calculating unit 34 assigns the calculated error vector to the output layer of the neural network 20.

The repetition control unit 36 performs repetition control for each of a plurality of pieces of training information. Specifically, the repetition control unit 36 executes a forward direction process of assigning the input vector included in the training information to the input layer of the neural network 20, causing the neural network 20 to propagate operation data in a forward direction, and causing the output vector to be output from the output layer. Then, the repetition control unit 36 assigns the output vector output in the forward direction process to the error calculating unit 34, and acquires the error vector from the error calculating unit 34. Then, the repetition control unit 36 executes a reverse direction process of assigning the acquired error vector to the output layer of the neural network 20 and causing the neural network 20 to propagate error data in a reverse direction.

Each time the neural network 20 executes a set of forward direction process and reverse direction process, the update unit 38 updates each of a plurality of weight coefficients included in the neural network 20 so that the neural network 20 is optimized for a predetermined application. For example, the update unit 38 may update the weight coefficients after one piece of training information is propagated in the forward direction and the reverse direction or may update the weight coefficients collectively for a plurality of pieces of training information after a plurality of pieces of training information are propagated in the forward direction and the reverse direction.

The specifying unit 40 specifies an inactive node and an inactive channel among a plurality of nodes and a plurality of channels included in the neural network 20. For example, after the update unit 38 executes the updating of the weight coefficients a predetermined number of times, the specifying unit 40 specifies the inactive node and the inactive channel.

For example, the specifying unit 40 specifies a node and a channel for which norms of weight vectors are a predetermined threshold value or less as the inactive node and the inactive channel. For example, the specifying unit 40 specifies a node and a channel in which a result of adding absolute values of all set weight coefficients is a predetermined threshold value or less as the inactive node and the inactive channel. Here, the predetermined threshold value is a small value very close to 0. Accordingly, the specifying unit 40 can specify a node and a channel for which norms of weight vectors are 0 or values close to 0 which hardly contributes to an operation in the neural network 20 as the inactive node and the inactive channel. As described above, a phenomenon that the norms of the weight vectors for the node or the channel are a predetermined threshold value or less, and hardly contributes to the operation in the neural network 20 is referred to as a group sparse.

The deleting unit 42 deletes the inactive node and the inactive channel specified by the specifying unit 40 from the neural network 20. For example, after the update unit 38 executes the updating of the weight coefficient a predetermined number of times, the deleting unit 42 rewrites the configuration information of the neural network 20 stored in the executing unit 24, and deletes the inactive node and the inactive channel from the neural network 20. Further, in a case in which the inactive node and the inactive channel are deleted, biases set in the inactive node and the inactive channel are compensated. For example, after deleting the inactive nodes, the inactive channel, and corresponding weight vectors, the deleting unit 42 combines the biases for the inactive node and the inactive channel with biases for a node or a channel of a next layer. Accordingly, the deleting unit 42 can prevent an inference result from varying greatly with the deletion of the inactive node and the inactive channel.

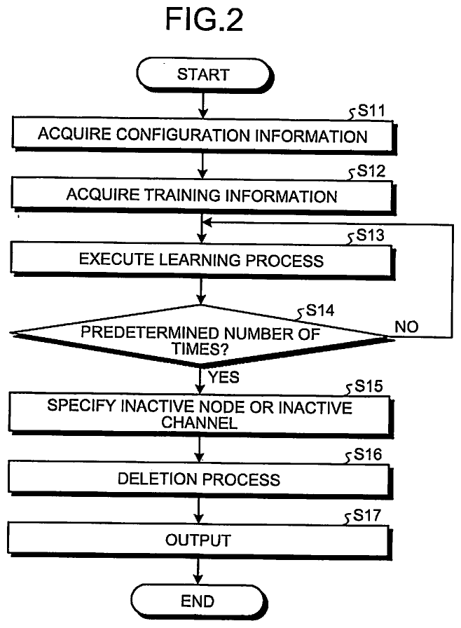

FIG. 2 is a diagram illustrating a process flow of the learning device 10 according to the first embodiment. The learning device 10 according to the first embodiment executes a process in accordance with a flow illustrated in FIG. 2.

First, in S11, the learning device 10 acquires the configuration information of the neural network 20 from an external device or the like. Then, in S12, the learning device 10 acquires a plurality of pieces of training information.

Then, in S13, the learning device 10 executes the learning process on the neural network 20 by using one of a plurality of pieces of training information. Then, in S14, the learning device 10 determines whether or not the learning processes has been executed predetermined times. When the learning process has not been executed predetermined times (No in S14), the learning device 10 repeats the process of S13. When a predetermined number of learning processes have been executed (Yes in S14), the process proceeds to S15.

In S15, the learning device 10 specifies the inactive node and the inactive channel among a plurality of nodes and a plurality of channels included in the neural network 20 after the learning process. Then, in S16, the learning device 10 deletes the specified inactive node and the specified inactive channel from the neural network 20. In S17, the learning device 10 outputs the neural network 20 from which the inactive node and the inactive channel have been deleted to the external device or the like.

The learning device 10 according to the first embodiment can optimize the neural network 20 for a predetermined application by executing the above process. The learning device 10 may further optimize the neural network 20 by executing the learning process again after deleting the inactive node and the inactive channel. In second and subsequent learning processes, the learning device 10 may perform accuracy compensation without performing the specifying and the deleting of the inactive node and the inactive channel or may further reduce the size of the neural network 20 by performing the specifying and the deleting of the inactive node and the inactive channel.

Here, an activation function including an interval of an input value at which a differential function becomes 0 or an interval of an input value at which the differential function is asymptotic to 0 is set in all nodes and channels included in all intermediate layers of the neural network 20. For example, the activation function is a function in which, in the differential function, an interval of an input value on a positive side further than a predetermined input value is larger than 0, and an interval of an input value on a negative side further than a predetermined input value is 0 or asymptotic to 0.

For example, a Rectified Linear Unit (ReLU), an Exponential Linear Unit (ELU), or a hyperbolic tangent (TANH) is set in all nodes and channels included in all the intermediate layers of the neural network 20 as the activation function.

Soft Sign, Soft Plus, Scaled Exponential Linear Units (SeLU), Shifted ReLU, Thresholded ReLU, Clipped ReLU, Concatenated Rectified Linear Units (CReLU), or Swish may be set in all nodes and channels included in all the intermediate layers of neural network 20 as the activation function.

Content of each function described above will be described later in detail.

Further, the update unit 38 updates each of a plurality of weight coefficients included in the neural network 20 so as to minimize an objective function obtained by adding a basic loss function and an L2 regularization term multiplied by a regularization strength. The term “objective function” may further include another term in a term obtained by adding the basic loss function and the L2 regularization term multiplied by the regularization strength. The L2 regularization term is a sum of squares of all the weight coefficients. Further, the regularization strength is a non-negative value. The objective function obtained by adding the basic loss function and the L2 regularization term obtained by multiplying the regularization strength is also referred to as a cost function into which the L2 regularization term is introduced.

Furthermore, for each of a plurality of weight coefficients included in the neural network 20, the update unit 38 calculates a gradient of the weight coefficient on the basis of the objective function. Then, for each of a plurality of weight coefficients included in the neural network 20, the update unit 38 calculates a step width on the basis of the gradient and a past gradient of a corresponding weight coefficient, and updates the weight coefficient so that the objective function is decreased on the basis of the calculated step width. For example, the update unit 38 updates the weight coefficient by subtracting the step width from the previous weight coefficient.

For example, the update unit 38 calculates the step width using a parameter obtained by adding the current gradient and a moving average of the past gradients at a predetermined ratio for the corresponding weight coefficient, and updates the weight coefficient on the basis of the calculated step width. The moving average of the past gradients may be a weighted moving average. For example, the moving average of the past gradients is an average obtained by weighting and adding so that an influence degree of a past value is gradually reduced (that is, so that an influence degree of a value closer to the present value is made larger than the past value). Further, the moving average of the past gradients may be a cumulative moving average or a weighted cumulative moving average obtained by averaging all past gradients.

Further, the update unit 38 may calculate the step width using a parameter obtained by adding a square of the current gradient and a mean square of the past gradients at a predetermined ratio for a corresponding weight coefficient and update the weight coefficient on the basis of the calculated step width. Further, in addition to the gradient or the square of the gradient, the weight coefficient may be updated using a parameter obtained by adding the current value calculated by using the gradient and a moving average or a weighted moving average of past values at a predetermined ratio.

For example, the update unit 38 updates the weight coefficient using an algorithm of Adam or an algorithm of RMSprop as an algorithm for optimization. Further, for example, the update unit 38 updates the weight coefficient using an algorithm of AdaDelta, an algorithm of RMSpropGraves, an algorithm of SMORMS3, an algorithm of AdaMax, an algorithm of Nadam, an algorithm of Adam-HD, or the like.

In a case in which the neural network 20 is optimized under the above conditions, a possibility of the occurrence of the inactive node and the inactive channel increases. Therefore, by optimizing the neural network 20 under the above-described conditions, the learning device 10 according to the first embodiment can reduce the size of the neural network 20 while suppressing the accuracy deterioration.

### Second Embodiment

Next, a learning device 10 according to a second embodiment will be described. Since the learning device 10 according to the second embodiment has substantially the same functions and configuration as those of the first embodiment, elements having substantially the same functions and configurations are denoted by the same reference numerals, and detailed descriptions thereof except for differences will be omitted. The same applies to third and subsequent embodiments.

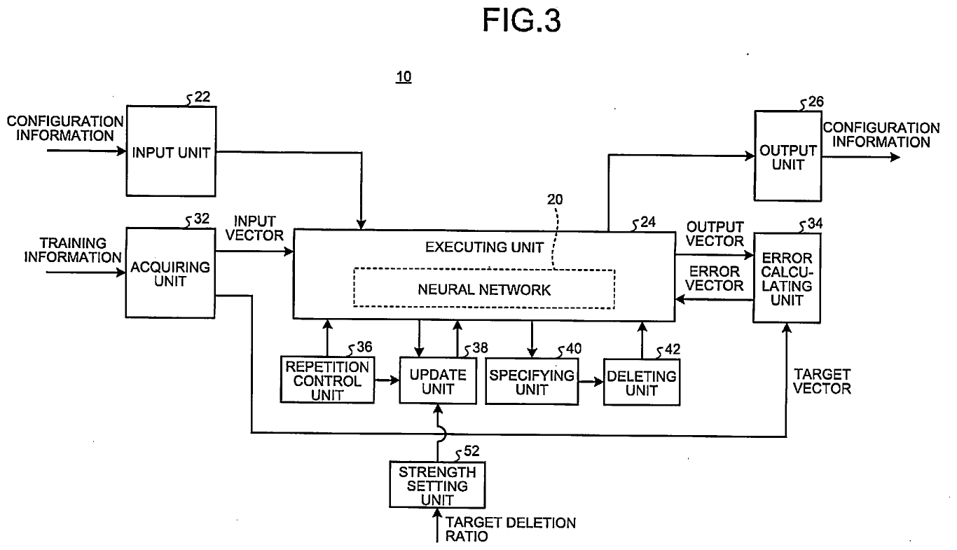

FIG. 3 is a diagram illustrating a configuration of the learning device 10 according to the second embodiment. The learning device 10 according to the second embodiment further includes a strength setting unit 52.

The strength setting unit 52 acquires a target deletion ratio from an external device or the like. The deletion ratio indicates a ratio of a size (a size after optimization) of the neural network 20 after deleting the inactive node and the inactive channel to a size (a size before optimization) of the original neural network 20. The size of the neural network 20 is, for example, the number of nodes or the number of channels of the neural network 20 or a total of the number of all weight coefficients set in the neural network 20.

The strength setting unit 52 changes a regularization strength in the update unit 38 in accordance with to the acquired target deletion ratio. The regularization strength is a non-negative parameter by which the L2 regularization term (a square sum of all the weight coefficients) in the objective function is multiplied.

The strength setting unit 52 changes the regularization strength so that the regularization strength increases as the target deletion ratio increases. In other words, the strength setting unit 52 changes the regularization strength so that as the regularization strength decreases the target deletion ratio decreases. For example, the strength setting unit 52 decides the regularization strength on the basis of the target deletion ratio with reference to a table in which a correspondence relation between the target deletion ratio and the regularization strength is registered. For example, the strength setting unit 52 decides the regularization strength on the basis of the target deletion ratio by using a function indicating the correspondence relation between the target deletion ratio and the regularization strength.

Here, when the learning process is executed under the condition described in the first embodiment, the size after the neural network 20 is optimized decreases as the regularization strength increase. Conversely, the size after the neural network 20 is optimized increases as the regularization strength decrease. Therefore, the learning device 10 according to the second embodiment can adjust the size of the optimized neural network 20 by changing the regularization strength in accordance with the target deletion ratio.

### Third Embodiment

Next, a learning device 10 according to a third embodiment will be described.

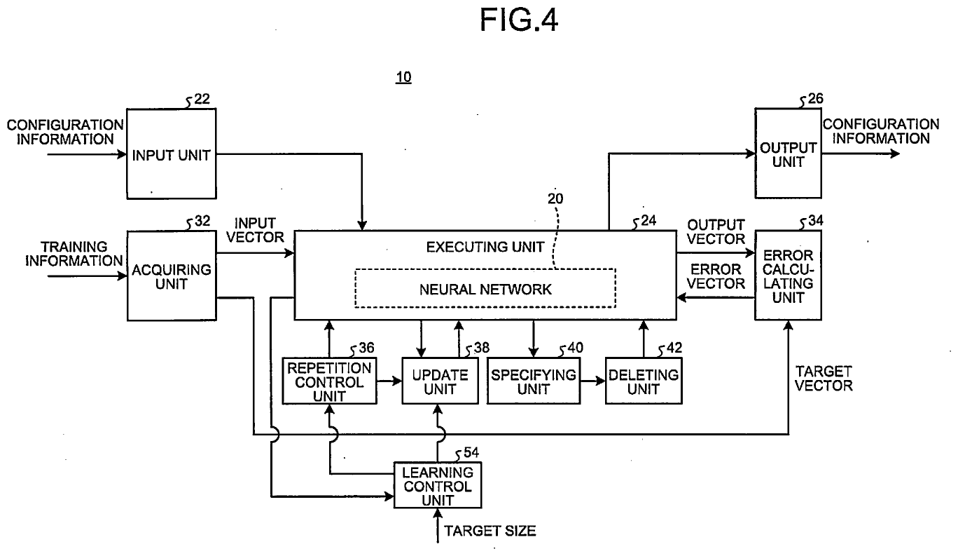

FIG. 4 is a diagram illustrating a configuration of the learning device 10 according to the third embodiment. The learning device 10 according to the third embodiment further includes a learning control unit 54.

The learning control unit 54 acquires a target size from an external device or the like. The target size is a size (a size after optimization) of the neural network 20 after the inactive node and the inactive channel are deleted.

After the deleting unit 42 deletes the inactive node or the inactive channel, the learning control unit 54 determines whether or not a size of the neural network 20 from which the inactive node and the inactive channel have been deleted is the target size or less. If it is the target size or less, the learning control unit 54 causes the learning process to be stopped.

If it is not the target size or less, the learning control unit 54 causes the learning process to be executed again, causes each of a plurality of weight coefficients to be updated again in the neural network 20 from which the inactive node and the inactive channel have been deleted, and causes the inactive node or the inactive channel to be deleted. The learning control unit 54 may execute the learning process a plurality of times while adjusting the regularization strength to be as close to the target size as possible. Accordingly, the learning control unit 54 can reduce the size of the neural network 20 after the inactive node and the inactive channel are deleted.

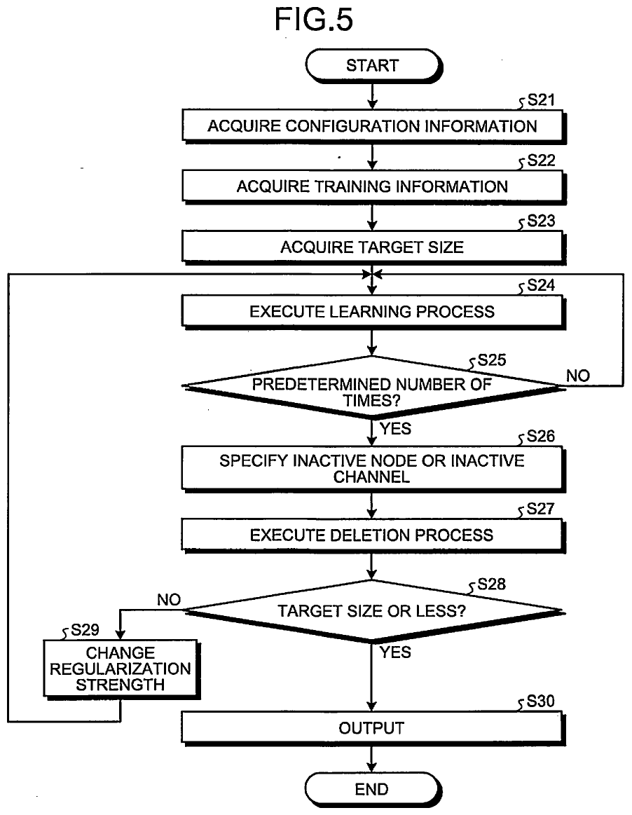

FIG. 5 is a diagram illustrating a process flow of the learning device 10 according to the third embodiment. The learning device 10 according to the third embodiment executes a process in accordance with a flow illustrated in FIG. 5.

First, in S21, the learning device 10 acquires the configuration information of the neural network 20 from an external device or the like. Then, in S22, the learning device 10 acquires a plurality of pieces of training information. Then, in S23, the learning device 10 acquires the target size of the neural network 20.

Then, in S24, the learning device 10 executes the learning process on the neural network 20 using one of a plurality of pieces of training information. Then, in S25, the learning device 10 determines whether or not the learning processes has been executed predetermined times. When the learning process has not been executed predetermined times (No in S25), the learning device 10 repeats the process of S24. When the learning process has been executed predetermined times (Yes in S25), the process proceeds to S26.

In S26, the learning device 10 specifies the inactive node and the inactive channel among a plurality of nodes and a plurality of channels included in the neural network 20 after the learning process. Then, in S27, the learning device 10 deletes the specified inactive node and the specified inactive channel from the neural network 20.

Then, in S28, the learning device 10 determines whether or not the size of the neural network 20 after the inactive node and the inactive channel are deleted is the target size or less. If it is not the target size or less (No in S28), the process proceeds to S29. In S29, the learning device 10 changes the regularization strength. If S29 ends, the learning device 10 causes the process to return to S24, and repeats the process from S24. The learning device 10 may cause the process to return to S24 without change without executing the process of S29.

When the size of the neural network 20 after the inactive node and the inactive channel are deleted is the target size or less (Yes in S28), the process proceeds to S30. In S30, the learning device 10 outputs the neural network 20 from which the inactive node and the inactive channel have been deleted to an external device or the like. In S29, the learning device 10 changes the regularization strength so that the size of the neural network 20 gradually approaches the target size each time the process from S24 to S27 is repeated. For example, the learning device 10 may increase the regularization strength so that a plurality of nodes or channels can be deleted in the first learning process and decrease the regularization strength so that the neural network 20 approaches the target size in the second and subsequent learning process.

As described above, the learning device 10 repeats the learning process of the neural network 20 and the process of deleting the inactive node and the inactive channel until the target size is reached. Accordingly, the learning device 10 can generate the neural network 20 of the target size while suppressing the accuracy deterioration.

### Fourth Embodiment

Next, an automatic driving system 110 according to a fourth embodiment will be described.

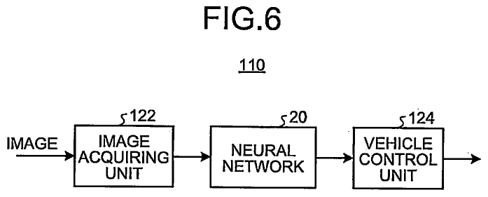

FIG. 6 is a diagram illustrating a configuration of the automatic driving system 110 according to the fourth embodiment. The automatic driving system 110 is a system that assists vehicle driving. For example, the automatic driving system 110 recognizes an image captured by a camera attached to a vehicle and performs vehicle driving control on the basis of a recognition result. For example, the automatic driving system 110 recognizes a pedestrian, a vehicle, a signal, an indicator, a lane, or the like, and performs the vehicle driving control.

The automatic driving system 110 includes an image acquiring unit 122, a neural network 20, and a vehicle control unit 124. The image acquiring unit 122 acquires an image captured by a camera attached to a vehicle. The image acquiring unit 122 assigns the acquired image to the neural network 20.

The neural network 20 is optimized in accordance with one of the first to third embodiments. For example, the neural network 20 recognizes objects such as a pedestrian, a vehicle, a signal, an indicator, a lane, and the like from the captured image. The vehicle control unit 124 executes a control process on the basis of a recognition result output from the neural network 20. For example, the vehicle control unit 124 controls the vehicle and gives an alert to a driver.

The automatic driving system 110 uses the neural network 20 with the reduced size while suppressing the accuracy deterioration. Accordingly, the automatic driving system 110 can execute vehicle control or the like with a high degree of accuracy through a simple configuration.

The neural network 20 optimized according to any one of the first to third embodiments can be applied not only to the automatic driving system 110 but also to other applications. For example, the neural network 20 can be applied to an infrastructure maintenance system. The neural network 20 applied to the infrastructure maintenance system detects a degree of deterioration of an iron bridge, a bridge, or the like from an image captured by a camera mounted on a drone or the like.

For example, the neural network 20 can be applied to a heavy particle radiotherapy system. The neural network 20 applied to the heavy particle radiotherapy system rapidly recognizes an organ, a tumor, or the like from an image captured inside a body and supports beam irradiation.

### Activation Function

Next, the activation function set in each node or channel of the intermediate layer of the neural network 20 will be described. “x” indicates an input value of the activation function. “y” indicates an output value of the activation function. “α” and “β” are predetermined values or values decided by the learning process.

The neural network 20 can use ReLU as the activation function. ReLU is a function indicated by the following Formula (1).

$$y = max ( 0 , x ) \qquad ( 1 )$$

max(a, b) is a function that outputs a larger one of “a” and “b.”

The neural network 20 can use ELU as the activation function. ELU is a function indicated by the following Formula (2).

$$y = \{ \begin{matrix}x & x \geq 0 \\ α ( {e}^{x} - 1 ) & x < 0\end{matrix} \qquad ( 2 )$$

The neural network 20 can use hyperbolic tangent as the activation function. The hyperbolic tangent is a function indicated by the following Formula (3).

$$y = tanh ( x ) \qquad ( 3 )$$

The neural network 20 can use Soft Sign as the activation function. Soft Sign is a function indicated by the following Formula (4).

$$y = \frac{x}{1 + \vert x \vert} \qquad ( 4 )$$

The neural network 20 can use Soft Plus as the activation function. Soft Plus is a function expressed by the following Formula (5).

$$y = log ( 1 + {e}^{x} ) \qquad ( 5 )$$

The neural network 20 can use SeLU as the activation function. SeLU is a function expressed by the following Formula (6).

$$y = β \{ \begin{matrix}x & x \geq 0 \\ α ( {e}^{x} - 1 ) & x < 0\end{matrix} \qquad ( 6 )$$

The neural network 20 can use Shifted ReLU as the activation function. Shifted ReLU is a function indicated by the following Formula (7).

$$y = max ( α , x ) \qquad ( 7 )$$

The neural network 20 can use Thresholded ReLU as the activation function. Thresholded ReLU is a function indicated by the following Formula (8).

$$y = \{ \begin{matrix}0 & x < α \\ x & x \geq α\end{matrix} \qquad ( 8 )$$

The neural network 20 can use Clipped ReLU as the activation function. Clipped ReLU is a function expressed by the following Formula (9).

$$y = \{ \begin{matrix}0 & x < 0 \\ x & 0 \leq x < α \\ α & x \geq α\end{matrix} \qquad ( 9 )$$

The neural network 20 can use CReLU as the activation function. CReLU is a function indicated by the following Formula (10). The function of Formula (10) outputs two values for one input value x.

$$y = ( Re LU ( x ) , Re LU ( - x ) ) \qquad ( 10 )$$

The neural network 20 can use Swish as the activation function. Swish is a function indicated by the following Formula (11).

$$y = x \cdot σ ( α x ) \qquad ( 11 )$$

σ(a) is a sigmoid function having “a” as an input value.

The learning devices 10 according to the first to third embodiments optimize the neural networks 20 in which the above activation functions are set in all nodes and channels included in all the intermediate layers. Accordingly, the learning device 10 can optimize the neural network 20 for a predetermined application and reduce the size while suppressing the accuracy deterioration.

### Optimization Problem

Next, an optimization problem applied by the learning device 10 will be described.

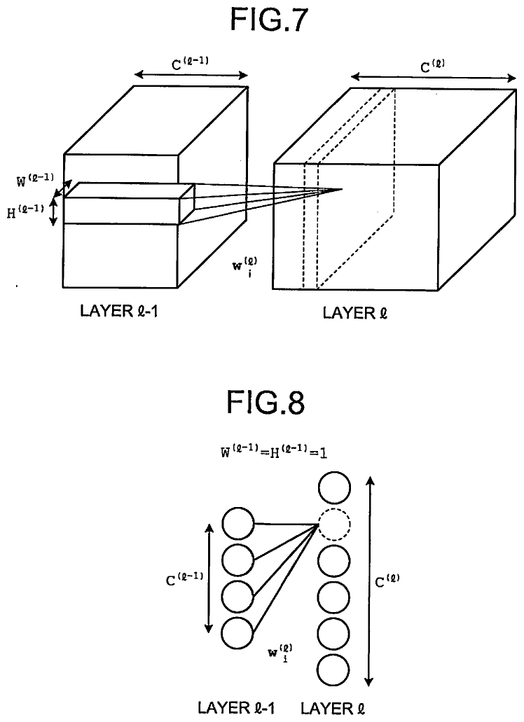

FIG. 7 is a diagram illustrating a weight coefficient of a convolution layer in the neural network 20. FIG. 8 is a diagram illustrating a weight coefficient of a fully connected layer in the neural network 20.

In the present example, an input vector to the neural network 20 is indicated as in Formula (12) below.

$$u ∈ {R}^{{D}_{U}} \qquad ( 12 )$$

In the present example, target of the output vector is indicated as in Formula (13) below.

$$v ∈ {R}^{{D}_{V}} \qquad ( 13 )$$

The learning device 10 optimizes the neural network 20 using N mini batch samples indicated by the following Formula (14). The learning device 10 selects the mini batch sample each time the weight coefficient is updated.

$${\{ {u}_{i} , {v}_{i} \}}_{i = 1}^{N} \qquad ( 14 )$$

The weight coefficient of the neural network 20 is indicated as in Formula (15) below.

$${\{ {W}^{( ℓ )} = ( {w}_{1}^{( ℓ )} , {w}_{2}^{( ℓ )} , … {w}_{{C}^{( ℓ )}}^{( ℓ )} ) ∈ {R}^{{W}^{( ℓ - 1 )} {H}^{( ℓ - 1 )} {C}^{( ℓ - 1 )} \times {C}^{( ℓ )}} \}}_{ℓ = 2}^{L} \qquad ( 15 )$$

“l” indicates the layer number. “L” indicates the number of layers of the neural network 20. A matrix indicating vectors of all weight coefficients from an (l-1) layer to an l layer is included in brackets in Formula (15). This matrix includes vectors of weight coefficients of each channel in each column.

In Formula (15), W^{(l-1)} and H^{(l-1)} indicate a lateral width and a longitudinal width of a kernel as illustrated in FIG. 7. C^{(l-1)} and C^{(l)} indicate the number of input channels and the number of output channels. In the case of the fully connected layer, the number of channels is the number of nodes. Therefore, w^{(l-1)}=H^{(l-1)}=1 as illustrated in FIG. 8.

The bias of neural network 20 is indicated as in Formula (16) below.

$${\{ {b}^{( ℓ )} = {( {b}_{1}^{( ℓ )} , {b}_{2}^{( ℓ )} , … , {b}_{{C}^{( ℓ )}}^{( ℓ )} )}^{T} ∈ {R}^{{C}^{( ℓ )}} \}}_{ℓ = 2}^{L} \qquad ( 16 )$$

The neural network 20 uses the same activation function (η(⋅)) in all layers excluding the final layer (l=L). Therefore, the input vector assigned to each layer is indicated as in Formula (17) below.

$${x}^{( ℓ )} = η ( {W}^{{( ℓ )}^{T}} {x}^{( ℓ - 1 )} + {b}^{( ℓ )} ) \qquad ( 17 )$$

Formula (17) is a notation for the fully connected layer. For the convolution layer, it is necessary to calculate x^{(l)} for each pixel position of an image. However, in the present example, the notation of Formula (17) is used for simplicity.

In a case in which the neural network 20 is defined as described above, the optimization problem applied by the learning device 10 is defined by the following Formula (18).

$${min}_{{\{ {W}^{( ℓ )} , {b}^{( ℓ )} \}}_{ℓ = 2}^{L}} E ( {\{ {u}_{i} , {v}_{i} \}}_{i = 1}^{N} , {\{ {W}^{( ℓ )} , {b}^{( ℓ )} \}}_{ℓ = 2}^{L} ) = {min}_{{\{ {W}^{( ℓ )} , {b}^{( ℓ )} \}}_{ℓ = 2}^{L}} \frac{1}{N} {\sum }_{i = 1}^{N} L ( {u}_{i} , {v}_{i} , {\{ {W}^{( ℓ )} , {b}^{( ℓ )} \}}_{ℓ = 2}^{L} ) + \frac{λ}{2} {\sum }_{ℓ = 2}^{L} {‖ {W}^{( ℓ )} ‖}_{F}^{2} ( λ > 0 ) . \qquad ( 18 )$$

In Formula (18), L(⋅) is the basic loss function. λ is the regularization strength. λ is a non-negative value.

As indicated in Formula (18), the optimization problem applied by the learning device 10 is defined so that the objective function obtained by adding the basic loss function and the L2 regularization term multiplied by the regularization strength.

A weight vector for a k-th channel in a l-th layer is indicated by the following Formula (19).

$${w}_{k}^{( ℓ )} \qquad ( 19 )$$

In this case, the gradient for the weight vector for the k-th channel in the l-th layer is indicated by the following Formula (20).

$${g}_{k}^{( ℓ )} = \frac{\partial E ( {\{ {u}_{i} , {v}_{i} \}}_{i = 1}^{N} , {\{ {W}^{( ℓ )} , {b}^{( ℓ )} \}}_{ℓ = 2}^{L} )}{\partial {w}_{k}^{( ℓ )}} = \frac{1}{N} {\sum }_{i = 1}^{N} \frac{\partial L ( {u}_{i} , {v}_{i} , {\{ {W}^{( ℓ )} , {b}^{( ℓ )} \}}_{ℓ = 2}^{L} )}{\partial {x}_{ik}^{( ℓ )}} \frac{\partial {x}_{ik}^{( ℓ )}}{\partial {w}_{k}^{( ℓ )}} + λ {w}_{k}^{( ℓ )} \qquad ( 20 )$$

For example, when the activation function (η(⋅)) is ReLU, the following Formula (21) is held.

$$\frac{\partial {x}_{ik}^{( ℓ )}}{\partial {w}_{k}^{( ℓ )}} = \{ \begin{matrix}{x}_{1}^{( ℓ - 1 )} & {w}_{k}^{{( ℓ )}^{T}} {x}_{1}^{( ℓ - 1 )} + {b}_{k}^{( ℓ )} > 0 \\ 0 & {w}_{k}^{{( ℓ )}^{T}} {x}_{1}^{( ℓ - 1 )} + {b}_{k}^{( ℓ )} \leq 0\end{matrix} \qquad ( 21 )$$

Therefore, when the activation function (η(⋅)) is ReLU, the gradient for the weight vector for the k-th channel in the l-th layer is indicated by the following Formula (22).

$${g}_{k}^{( ℓ )} = \frac{1}{N} {\sum }_{j : {w}_{k}^{{( ℓ )}^{T}} {x}_{j}^{( ℓ - 1 )} + {b}_{k}^{( ℓ )} > 0} \frac{\partial L ( {u}_{j} , {v}_{j} , {\{ {W}^{( ℓ )} , {b}^{( ℓ )} \}}_{ℓ = 2}^{L} )}{\partial {x}_{jk}^{( ℓ )}} {x}_{j}^{( ℓ - 1 )} + λ {w}_{k}^{( ℓ )} \qquad ( 22 )$$

Further, the learning device 10 updates the weight coefficients included in the neural network 20 to minimize the gradient using a predetermined optimization algorithm.

The learning devices 10 according to the first to third embodiments solve the optimization problem for minimizing the objective function obtained by adding the basic loss function and the L2 regularization term multiplied by the regularization strength and optimize the neural network 20. Accordingly, the learning device 10 can optimize the neural network 20 for a predetermined application and reduce the size while suppressing the accuracy deterioration.

### Optimization Algorithm

Next, the optimization algorithm applied by the learning device 10 will be described. The update unit 38 of the learning device 10 updates the weight coefficients included in the neural network 20 using the optimization algorithm described below.

In Formulas in the following description, “w” indicates a weight coefficient to be optimized. E(w) indicates an objective function used for optimization. “g” is a gradient of the objective function. “t” indicates the number of iterations.

In Formulas in the following description, “η” is a constant indicating a learning rate. “ε” is a constant. ρ, ρ₁, ρ₂, and ρₜ are constants that are larger than 0 and smaller than 1 and are values indicating how much the past parameter affects the current parameter.

The update unit 38 can update the weight coefficients included in the neural network 20 using the algorithm of Adam. In Adam, the weight coefficient is updated in accordance with the following Formula (23).

$${g}^{( t )} = ∇ E ( {w}^{( t )} ) \qquad ( 23 )$$

$${m}_{t} = {ρ}_{1} {m}_{t - 1} + ( 1 - {ρ}_{1} ) {g}^{( t )}$$

$${v}_{t} = {ρ}_{2} {v}_{t - 1} + ( 1 - {ρ}_{2} ) {( {g}^{( t )} )}^{2}$$

$${\hat{m}}_{t} = \frac{{m}_{t}}{1 - {ρ}_{1}^{t}}$$

$${\hat{v}}_{t} = \frac{{v}_{t}}{1 - {ρ}_{2}^{t}}$$

$$Δ {w}^{( t )} = - \frac{η}{\sqrt{{\hat{v}}_{t} + ε}} {\hat{m}}_{t}$$

$${w}^{( t + 1 )} = {w}^{( t )} + Δ {w}^{( t )}$$

Further, the update unit 38 can update the weight coefficients included in the neural network 20 using the algorithm of RMSprop. In RMSprop, the weight coefficient is updated in accordance with the following Formula (24).

$${g}^{( t )} = ∇ E ( {w}^{( t )} ) \qquad ( 24 )$$

$${v}_{t} = ρ {v}_{t - 1} + ( 1 - ρ ) {( {g}^{( t )} )}^{2}$$

$$Δ {w}^{( t )} = - \frac{η}{\sqrt{{v}_{t} + ε}} {g}^{( t )}$$

$${w}^{( t + 1 )} = {w}^{( t )} + Δ {w}^{( t )}$$

Further, the update unit 38 can update the weight coefficients included in the neural network 20 using the algorithm of AdaDelta. In AdaDelta, the weight coefficient is updated in accordance with the following Formula (25).

$${g}^{( t )} = ∇ E ( {w}^{( t )} ) \qquad ( 25 )$$

$${v}_{t} = ρ {v}_{t - 1} + ( 1 - ρ ) {( {g}^{( t )} )}^{2}$$

$$Δ {w}^{( t )} = - \frac{\sqrt{{u}_{t - 1} + ε}}{\sqrt{{v}_{t} + ε}} {g}^{( t )}$$

$${u}_{t} = ρ {u}_{t - 1} + ( 1 - ρ ) {( Δ {w}^{( t )} )}^{2}$$

$${w}^{( t + 1 )} = {w}^{( t )} + Δ {w}^{( t )}$$

Further, the update unit 38 can update the weight coefficients included in the neural network 20 using the algorithm of RMSpropGraves. In RMSpropGraves, the weight coefficient is updated in accordance with the following Formula (26).

$${g}^{( t )} = ∇ E ( {w}^{( t )} ) \qquad ( 26 )$$

$${m}_{t} = {ρ}_{1} {m}_{t - 1} + ( 1 - {ρ}_{1} ) {g}^{( t )}$$

$${v}_{t} = {ρ}_{1} {v}_{t - 1} + ( 1 - {ρ}_{1} ) {( {g}^{( t )} )}^{2}$$

$$Δ {w}^{( t )} = η ( - {ρ}_{2} {w}^{( t - 1 )} - \frac{1}{\sqrt{{v}_{t} - {m}_{t}^{2}} + ε} {g}^{( t )} )$$

$${w}^{( t + 1 )} = {w}^{( t )} + Δ {w}^{( t )}$$

Further, the update unit 38 can update the weight coefficients included in the neural network 20 using the algorithm of SMORMS3. In the algorithm of SMORMS3, the weight coefficient is updated in accordance with the following Formula (27).

$${g}^{( t )} = ∇ E ( {w}^{( t )} ) \qquad ( 27 )$$

$${s}_{t} = 1 + ( 1 - {ζ}_{t - 1} ) {s}_{t - 1}$$

$${ρ}_{t} = \frac{1}{{s}_{t} + 1}$$

$${m}_{t} = {ρ}_{t} {m}_{t - 1} + ( 1 - {ρ}_{t} ) ( {g}^{( t )} )$$

$${v}_{t} = {ρ}_{t} {v}_{t - 1} + ( 1 - {ρ}_{t} ) {( {g}^{( t )} )}^{2}$$

$${ζ}_{t} = \frac{{m}_{t}^{2}}{{v}_{t} + ε}$$

$$Δ {w}^{( t )} = - \frac{min \{ η , {ζ}_{t} \}}{\sqrt{{v}_{t}} + ε} {g}^{( t )}$$

$${w}^{( t + 1 )} = {w}^{( t )} + Δ {w}^{( t )}$$

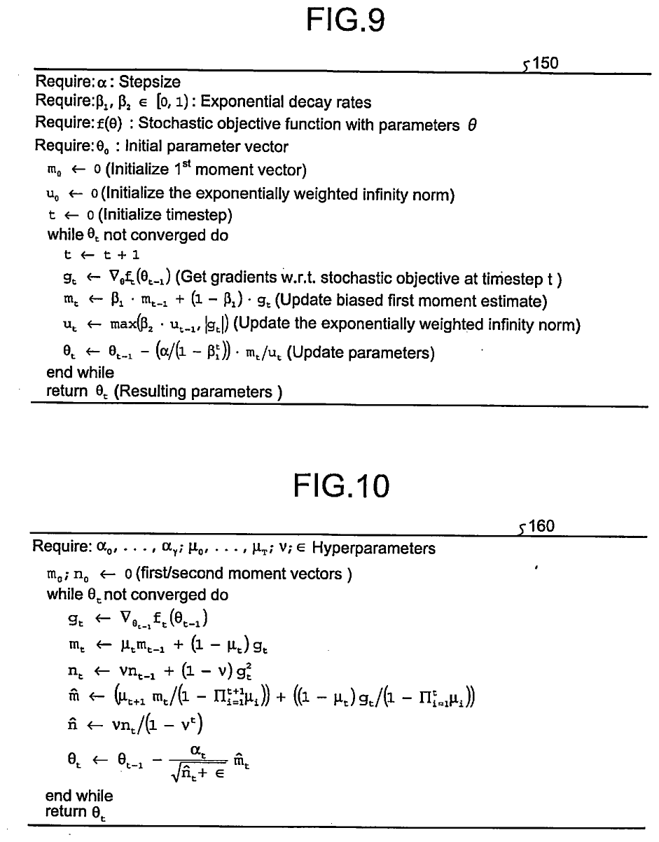

FIG. 9 is a diagram illustrating a pseudo code 150 indicating the optimization algorithm of the weight coefficient by AdaMax. The update unit 38 can update the weight coefficients included in the neural network 20 using the algorithm of AdaMax. In AdaMax, the weight coefficient is updated in accordance with the algorithm illustrated in FIG. 9.

FIG. 10 is a diagram illustrating a pseudo code 160 indicating the optimization algorithm of the weight coefficient by Nadam. The update unit 38 can update the weight coefficients included in the neural network 20 using an algorithm of Nadam. In Nadam, the weight coefficient is updated in accordance with the algorithm illustrated in FIG. 10.

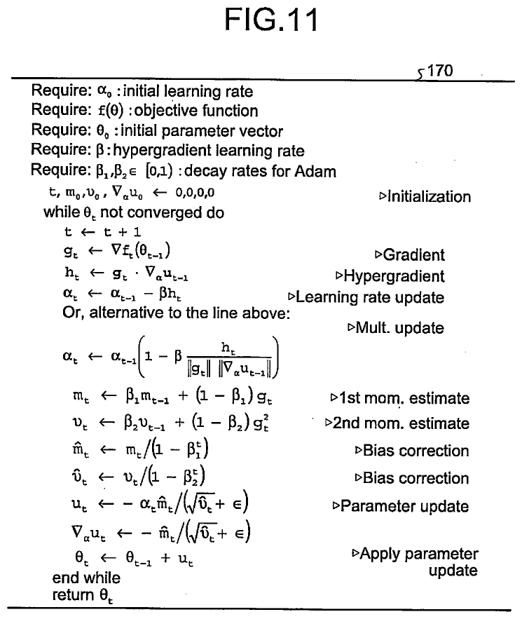

FIG. 11 is a diagram illustrating a pseudo code 170 illustrating the optimization algorithm of the weight coefficient by Adam-HD. The update unit 38 can update the weight coefficients included in the neural network 20 using the algorithm of Adam-HD. In Adam-HD, the weight coefficient is updated in accordance with the algorithm illustrated in FIG. 11.

The learning devices 10 according to the first to third embodiments optimize the neural network 20 using the above optimization algorithms. Accordingly, the learning device 10 can optimize the neural network 20 for a predetermined application and reduce the size while suppressing the accuracy deterioration.

### FIRST EXPERIMENT EXAMPLE

Next, a first experiment example will be explained.

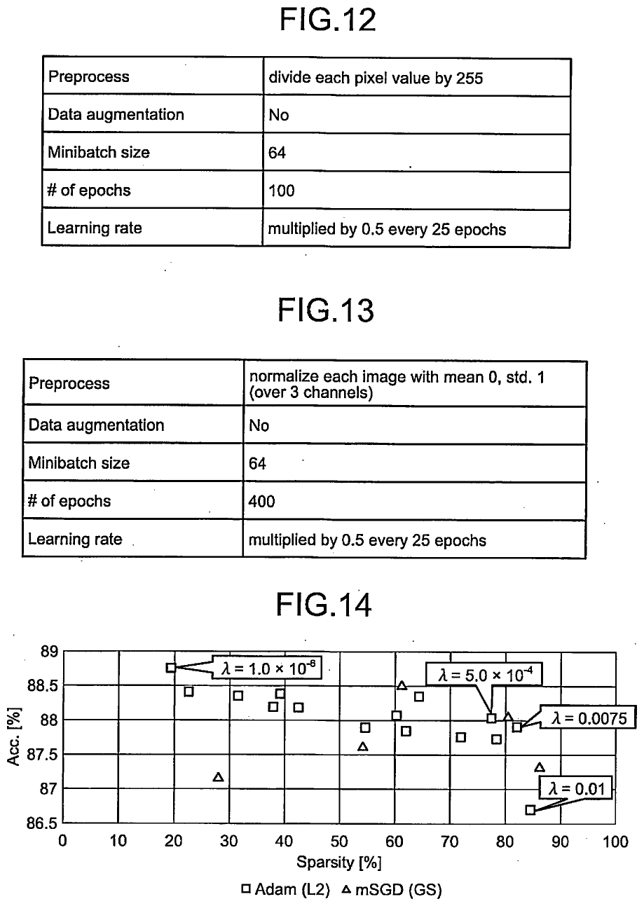

FIG. 12 is a diagram illustrating basic conditions in the first experiment example. In the first experiment example, the neural network 20 including the fully connected layer as the intermediate layer was optimized by the learning device 10. In the first experiment example, a MNIST data set was used as a plurality of pieces of training information. The MNIST data set is a data set of a gray-scale image (28×28) of handwritten digits of 10 patterns of 0 to 9. The number of images used for learning was 60,000, and the number of images used for validation was 10,000.

Further, in the first experiment example, for each piece of input data of the training information, a pixel value was normalized to a range of 0 to 1 by multiplying a pixel value by a value of 1/255. In the first experiment example, data augmentation was omitted. In the first experiment example, a mini batch size was set to 64. In the first experiment example, the number of epochs was set to 100. In the first experiment example, a basic learning rate was multiplied by 0.5 for every 25 epochs.

Furthermore, in the first experiment example, weight vectors satisfying conditions of the following Formula (28) were determined as weight vectors which have undergone group sparsity.

$${‖ {w}_{k}^{( ℓ )} ‖}_{2} < ξ \qquad ( 28 )$$

TABLE 1

| | Optimization solver | | | |
|---|---|---|---|---|
| | Adam | | | |
| | (baseline) | mSGD | adagrad | RMSprop |
| Validation Acc. [%] | 98.43 | 98.35 | 98.31 | 98.31 |
| Sparsity [%] | 70.00 | 0 | 0 | 65.20 |

Table 1 shows the validation accuracy (Validation Acc. [%]) and the rate of the weight vectors which have undergone group sparsity (sparse rate) (Sparsity [%]) in a case in which Adam(lr=0.001), momentum-SGD(mSGD) (lr=0.01) (N. Qian, “On the momentum term in gradient descent learning algorithms,” Neural Networks: The Official Journal of the International Neural Network Society, 12(1), 145 to 151, 1999), adagrad (lr=0.01) (J. Duchi, E. Hazan, and Y. Singer, “Adaptive Subgradient Methods for Online Learning and Stochastic Optimization,” Journal of Machine Learning Research, vol. 12, pp. 2121 to 2159, 2011), and RMSprop (lr=0.001) are used as an optimization solver for realizing the optimization algorithm in the first experiment example.

In the experiment of Table 1, in addition to the basic conditions, a threshold value of Formula (28) is set to ξ=1.0×10⁻¹⁵. Furthermore, in the experiment of Table 1, one layer is used as the intermediate layer of the neural network 20, the number of nodes of the intermediate layer is 1,000, and the activation function is ReLU. Furthermore, in the experiment of Table 1, the regularization strength of the L2 regularization term is set to λ=5.0×10⁻⁴, batch normalization is applied after the intermediate layer, and a technique of Xavier (X. Glorot and Y. Bengio, “Understanding the difficulty of training deep feedforward neural networks,” International Conference on Artificial Intelligence and Statistics (AISTATS), pp. 249 to 256, 2010) is used as an initialization value.

In the experiment of Table 1, it was confirmed that the weight vectors which have undergone the group sparsity are generated when the optimization solvers are RMSprop and Adam. RMSprop and Adam decide an update step width using an exponential moving average of squares of the gradient. Since RMSprop and Adam use the exponential moving average of the squares of the gradient, it is considered that the weight vectors which have undergone the group sparsity are generated. Therefore, it is predicted that the weight vectors which have undergone the group sparsity are generated even when other optimization solvers using the exponential moving average of the squares of the gradient such as, for example, AdaDelta are used.

TABLE 2

| | Activation function | | | |
|---|---|---|---|---|
| | ReLU | | | |
| | (baseline) | TANH | ELU | Sigmoid |
| Validation Acc. [%] | 98.43 | 98.39 | 98.27 | 98.42 |
| Sparsity [%] | 70.00 | 1.70 | 77.00 | 0 |

TABLE 3

| | Activation function | | | |
|---|---|---|---|---|
| | ReLU | | | |
| | (baseline) | TANH | ELU | Sigmoid |
| Validation Acc. [%] | 98.43 | 98.39 | 98.27 | 98.42 |
| Sparsity [%] | 70.0 | 27.7 | 77.1 | 0 |

Tables 2 and 3 show the validation accuracy and the rate of the weight vectors which have undergone group sparsity when ReLU, hyperbolic tangent (TANH), ELU, and sigmoid are used as the activation function in the first experiment example.

In the experiment in Table 2, a threshold value of Formula (28) is set to ξ=1.0×10⁻¹⁵. In the experiment in Table 3, a threshold value of Formula (28) is set to ξ=1.0×10⁻⁶.

In the experiment in Table 2 and the experiment in Table 3, Adam is used as the optimization solver. The other conditions in the experiment of Table 2 and the experiment of Table 3 are similar to those of the experiment of Table 1.

In the experiments of Tables 2 and 3, it was confirmed that the weight vectors which have undergone the group sparsity are generated when the activation function is ReLU, hyperbolic tangent (TANH), and ELU.

ReLU, hyperbolic tangent (TANH), and ELU are functions including an interval of an input value at which the differential function becomes 0 or an interval of an input value at which the differential function is asymptotic to 0. The activation function in which there is an interval of an input value at which the differential function becomes 0 (or an interval of an input value very close to 0) may have a small gradient. For this reason, in the vectors of the weight coefficients leading to such an activation function, a gradient toward an origin by the L2 regularization becomes more dominant than a gradient by the loss function, and as a result of repeating updating, the weight vectors which have undergone the group sparsity are considered to be generated. Therefore, the neural network 20 in which the activation function including the interval of the input value at which the differential function becomes 0 and the activation function including the interval of the input value at which the differential function is asymptotic to 0 is set, the weight vectors which have undergone the group sparsity are predicted to be generated.

Further, referring to Tables 2 and 3, ReLU and ELU have a large sparse rate. In ReLU and ELU, in the differential function, an interval of an input value on a positive side further than a predetermined input value (for example, an interval of an input value larger than 0) is larger than 0, and an interval of an input value on a negative side further than a predetermined input value (for example, an interval of an input value smaller than 0) is 0 or asymptotic to 0. In ReLU and ELU, as compared with hyperbolic tangent (TANH) and sigmoid, a possibility that an interval of an input value at which the differential function becomes 0 (or an interval of input value very close to 0), and the gradient becomes small is high. For this reason, in the neural network 20 using such an activation function, the gradient toward the origin by the L2 regularization becomes more dominant than the gradient by the loss function, and a possibility that the weight vectors which have undergone the group sparsity are generated is considered to be high accordingly. Therefore, in the neural network 20 in which the activation function in which, in the differential function, an interval of an input value on a positive side further than a predetermined input value (for example, an interval of an input value larger than 0) is larger than 0, and an interval of an input value on a negative side further than a predetermined input value (for example, an interval of an input value smaller than 0) is 0 or asymptotic to 0 is set, a large number of weight vectors which have undergone the group sparsity are predicted to be generated.

TABLE 4

| | Initialization | |
|---|---|---|
| | Xavier | |
| | (baseline) | He |
| Validation Acc. [%] | 98.43 | 98.42 |
| Sparsity [%] | 70.00 | 68.70 |

Table 4 shows the validation accuracy and the rate of the vectors of the weight coefficients which have undergone the group sparsity when a technique of Xavier and He (K. He, X. Zhang, S. Ren, and J. Sun, “Delving deep into rectifiers: Surpassing human-level performance on imagenet classification”. International Conference on Computer Vision (ICCV). 2015) are used as an initialization value in the first experiment example. In the experiment of Table 4, ReLU is used as the activation function, and Adam is used as the optimization solver. The other conditions in the experiment of Table 4 are similar to those in the experiment of Table 1.

In the experiment of Table 4, it was confirmed that the validation accuracy and the sparse rate are not affected even when Xavier or He is used as the initialization value. Therefore, it is predicted that even if the initialization value is changed, the number of weight vectors which have undergone the group sparsity is unable to be changed.

TABLE 5

| | Batch normalization | |
|---|---|---|
| | There is BN | |
| | (baseline) | There is no BN |
| Validation Acc. [%] | 98.43 | 98.26 |
| Sparsity [%] | 70.00 | 82.10 |

Table 5 shows the validation accuracy and the rate of the weight vectors which have undergone the group sparsity when there is batch normalization and when there is no batch normalization in the first experiment example. In the experiment of Table 5, ReLU is used as the activation function, and Adam is used as the optimization solver. The other conditions in the experiment of Table 5 are similar to those in the experiment of Table 1.

In the experiment of Table 5, it was confirmed that the sparse rate is not affected regardless of the presence or absence of batch normalization. Therefore, it is predicted that the number of weight vectors which have undergone the group sparsity is unable to be changed even when batch normalization is changed.

TABLE 6

| | L2 regularization term | |
|---|---|---|
| | There is L₂ | |
| | (baseline) | There is no L₂ |
| Validation Acc. [%] | 98.43 | 98.45 |
| Sparsity [%] | 70.00 | 0 |

Table 6 shows the validation accuracy and the rate of the vectors of the weight coefficients which have undergone the group sparsity when the L2 regularization term is applied and when the L2 regularization term is not applied (when the regularization strength is set to λ=0) in the first experiment example. In the experiment of Table 6, ReLU is used as the activation function, and Adam is used as the optimization solver. The other conditions in the experiment of Table 6 are similar to those of the experiment of Table 1.

In the experiment of Table 6, it was confirmed that the weight vectors which have undergone the group sparsity are not generated when the L2 regularization term is not applied (when the regularization strength is set to λ=0). Therefore, in the learning device 10, learning using the objective function to which the L2 regularization term is applied is predicted to be an essential condition for generating the weight vectors which have undergone the group sparsity.

TABLE 7

| | | | | | | |
|---|---|---|---|---|---|---|
| Number of | 10 | 50 | 100 | 500 | 1000 | 2000 |
| nodes | | | | | (baseline) | |
| Validation | 93.92 | 97.46 | 98.17 | 98.48 | 98.43 | 98.45 |
| Acc. [%] | | | | | | |
| Number of | 10 | 50 | 100 | 291 | 300 | 288 |
| remaining | | | | | | |
| nodes | | | | | | |

Table 7 shows the validation accuracy and the number of nodes (the number of remaining nodes) after a node deletion process is executed when the number of nodes of the intermediate layer is 10, 50, 100, 500, 1000 and 2000 in the first experiment example. In the experiment of Table 7, ReLU is used as the activation function, and Adam is used as the optimization solver. The other conditions in the experiment of Table 7 are similar to those in the experiment of Table 1.

In the experiment of Table 7, it was confirmed that the number of remaining nodes is equal to that before the node deletion process when the number of nodes of the intermediate layer is 10, 50, and 100. In other words, in the experiment of Table 7, when the number of nodes of the intermediate layer is 10, 50, and 100, the weight vectors which have undergone the group sparsity have not been generated. It is considered that the reason why the weight vectors which have undergone the group sparsity have not been generated when the number of nodes of the intermediate layer is 10, 50, and 100 is that the gradient is likely to occur since a loss is large in the neural network 20 with a relatively small configuration.

In the experiment of Table 7, it was confirmed that the number of remaining nodes is smaller than that before node reduction process when the number of nodes of the intermediate layer is 500, 1000, and 2000. In other words, in the experiment of Table 7, it was confirmed that, when the number of nodes of the intermediate layer is 500, 1000, and 2000, the weight vectors which have undergone the group sparsity are generated. When the number of nodes of the intermediate layer is 500, 1000, and 2000, the number of remaining nodes and the validation accuracy are substantially equal. For this reason, it is considered that the redundant configuration in the neural network 20 has been reduced by the experiment.

TABLE 8

| | Number of intermediate layers | | | | |
|---|---|---|---|---|---|
| | 1 | | | | |
| | (baseline) | 2 | 3 | 4 | 5 |
| Validation | 98.43 | 98.73 | 98.78 | 98.88 | 98.68 |
| Acc. [%] | | | | | |
| Number of | 1st: 300 | 1st: 128 | 1st: 153 | 1st: 177 | 1st: 168 |
| remaining | | 2nd: 227 | 2nd: 75 | 2nd: 78 | 2nd: 87 |
| nodes of | | | 3rd: 186 | 3rd: 76 | 3rd: 73 |
| each layer | | | | 4th: 160 | 4th: 75 |
| | | | | | 5th: 160 |

Table 8 shows the validation accuracy and the remaining number of nodes of each layer when the number of intermediate layers is 1, 2, 3, 4, and 5 in the first experiment example. In the experiment of Table 8, ReLU is used as the activation function, and Adam is used as the optimization solver. The other conditions in the experiment of Table 8 are similar to those of the experiment of Table 1.

In the experiment of Table 8, it was confirmed that, except for the intermediate layer of the final layer (the layer just before the output layer), the number of remaining nodes tended to decrease as the layer is deeper (the layer is getting closer to the final layer). It is considered that this tendency arises because the redundancy of the feature quantity increases as it goes to the deeper layer, but the gradient of the loss function is likely to propagate in the final layer.

### SECOND EXPERIMENT EXAMPLE

Next, a second experiment example will be described.

FIG. 13 is a diagram illustrating basic conditions in the second experiment example. The second experiment example is an example in which the neural network 20 including the convolution layer as the intermediate layer is optimized by the learning device 10. In the second experiment example, a CIFAR-10 data set was used as a plurality of pieces of training information. CIFAR-10 is a data set of a color image (32×32) indicating 10 patterns of general objects. In the second experiment example, the number of images used for learning was 50,000, and the number of images used for validation was 10,000. Further, a neural network 20 having 16 layers, that is, 13 convolution layers and 3 fully connected layers were used.

Further, in the second experiment example, for each piece of input data of training information, an average and a standard deviation of all pixel values over three channels were calculated, and the pixel values were normalized by subtracting the average from each pixel and dividing by the standard deviation. In the second experiment example, data augmentation was omitted. In the second experiment example, the mini batch size was set to 64. In the second experiment example, the number of epochs was set to 400. In the second experiment example, the learning rate was multiplied by 0.5 for every 25 epochs.

TABLE 9

Optimization solver

| | Validation Acc. | Sparsity |
|---|---|---|
| | [%] | [%] |
| mSGD (λ = 5.0 × 10⁻⁴) | 88.40 | 0 |
| Adam (λ = 5.0 × 10⁻⁴) | 88.06 | 77.46 |
| Adam (λ = 0) | 88.60 | 0.08 |
| AdamW (λ = 5.0 × 10⁻⁴) | 88.91 | 0.25 |
| AMSGRAD (λ = 5.0 × 10⁻⁴) | 88.76 | 0.95 |

Table 9 shows the validation accuracy and the rate of the weight vectors which have undergone group sparsity when mSGD (lr=0.01), Adam (lr=0.001), AdamW (lr=0.001) (I. Loshchilov and F. Hutter, “Fixing weight decay regularization in adam,” arXiv preprint arXiv:1711.05101, 2017), and AMSGRAD (lr=0.001) (S. J. Reddi, S. Kale, and S. Kumar, “On the Convergence of Adam and Beyond,” International Conference on Learning Representations (ICLR), 2018) are used as the optimization solver in the second experiment example. The validation accuracy is a maximum value among 400 epochs.

Table 9 shows the validation accuracy and the rate of the weight vectors which have undergone group sparsity when the regularization strength is set to λ=0 in Adam. For other optimization solvers, the regularization strength is λ=5.0×10⁻⁴. Since AdamW and AMSGRAD are devised so that decay in an origin direction by the L2 regularization does not become too large, the group sparsity does not occur.

In the experiment of Table 9, it was confirmed that it is possible to generate the weight vectors which have undergone the group sparsity for the neural network 20 including the convolution layer as the intermediate layer.

FIG. 14 is a diagram illustrating the validation accuracy with respect to the rate of the weight vectors which have undergone the group sparsity.

A plot of triangles in FIG. 14 is a relation between the sparse rate and the validation accuracy when the regularization strength (λ) is changed using mSGD, which is described in S. Scardapane, D. Comminiello, A. Hussain, and A. Uncini, “Group Sparse Regularization for Deep Neural Networks,” Neurocomputing, Vol. 241, pp. 81 to 89, 2017. In a case in which the method described in S. Scardapane, D. Comminiello, A. Hussain, and A. Uncini, “Group Sparse Regularization for Deep Neural Networks,” Neurocomputing, Vol. 241, pp. 81 to 89, 2017 is used, the relation between sparse rate and the validation accuracy have a large variation due to a setting of λ.

A plot of rectangles in FIG. 14 is a relation between the sparse rate and the validation accuracy when the regularization strength (λ) is changed using Adam in the second experiment example. From the plot of the rectangles in FIG. 14, it was confirmed that the validation accuracy tends to increase as the regularization strength (λ) decreases. Further, from the plot of the rectangles in FIG. 14, it was confirmed that the sparse rate increases as the regularization strength (λ) increases. Therefore, it is predicted that it is possible to control the sparse rate and the validation accuracy by changing the regularization strength (λ).

### Hardware Configuration

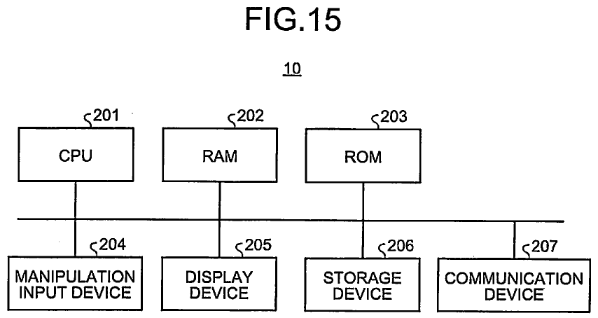

FIG. 15 is a diagram illustrating an example of a hardware configuration of the learning device 10 according to an embodiment. The learning device 10 according to the present embodiment is realized by, for example, an information processing device having a hardware configuration illustrated in FIG. 15. The learning device 10 includes a central processing unit (CPU) 201, a random access memory (RAM) 202, a read only memory (ROM) 203, a manipulation input device 204, a display device 205, a storage device 206, a communication device 207. These components are connected by a bus.

The CPU 201 is a processor that executes an operation process, a control process, or the like in accordance with a program. The CPU 201 executes various types of processes in cooperation with a program stored in the ROM 203, the storage device 206, or the like as a predetermined area of the RAM 202 as a work area.

The RAM 202 is a memory such as a synchronous dynamic random access memory (SDRAM). The RAM 202 functions as a work area of the CPU 201. The ROM 203 is a memory that stores a program and various types of information in a non-rewritable manner.

The manipulation input device 204 is an input device such as a mouse or a keyboard. The manipulation input device 204 receives information input by a user as an instruction signal and outputs the instruction signal to the CPU 201.

The display device 205 is a display device such as a liquid crystal display (LCD). The display device 205 displays various types of information on the basis of a display signal from the CPU 201.

The storage device 206 is a device that writes and reads data in a storage medium such as a semiconductor memory such as a flash memory, a magnetically or optically recordable storage medium, or the like. Under the control of the CPU 201, the storage device 206 writes or reads data to or from the storage medium. The communication device 207 communicates with an external device via a network under the control of the CPU 201.

The program executed by the learning device 10 of the present embodiment has a module configuration including an input module, an executing module, an output module, an acquiring module, an error calculating module, a repetition control module, an update module, a specifying module, and a deleting module. This program is developed onto the RAM 202 and executed by the CPU 201 (processor) and causes the information processing device to function as the input unit 22, the executing unit 24, the output unit 26, the acquiring unit 32, the error calculating unit 34, the repetition control unit 36, update unit 38, the specifying unit 40, and the deleting unit 42.

It should be noted that the learning device 10 is not limited to such a configuration and may be a configuration in which at least some of the input unit 22, the executing unit 24, the output unit 26, the acquiring unit 32, the error calculating unit 34, the repetition control unit 36, the update unit 38, the specifying unit 40, and the deleting unit 42 are implemented by a hardware circuit (for example, a semiconductor integrated circuit).

The program executed by the learning device 10 of the present embodiment is a file of an installable format or an executable format in a computer and provided in a form in which it is recorded in a computer-readable recording medium such as a CD-ROM, a flexible disk, a CD-R, or a digital versatile disk (DVD).

Further, the program executed by the learning device 10 of the present embodiment may be configured to be stored in a computer connected to a network such as the Internet and provided by downloading via a network. Further, the program executed by the learning device 10 of the present embodiment may be configured to be provided or distributed via a network such as the Internet. Further, the program executed by the learning device 10 may be configured to be provided in a form in which it is incorporated into the ROM 203 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-20. (canceled)

21. A learning method of optimizing a neural network implemented by an information processing device including one or more hardware processors, the method comprising:
by the one or more hardware processors,
acquiring configuration information of the neural network;
acquiring a plurality of pieces of training information including an input vector and a target vector serving as a target of an output vector;
executing a first processing of repeating executing a forward direction process, generating an error vector, executing a reverse direction process, and updating each of a plurality of weight coefficients a predetermined number of times;
in the forward direction process, assigning the input vector to an input layer of the neural network, causing operation data to be propagated in a forward direction, and causing the output vector to be output from an output layer;
in the generating of the error vector, generating the error vector based on the output vector and the target vector;
in the reverse direction process, assigning the error vector to the output layer of the neural network and causing error data to be propagated in a reverse direction;
in the updating of each of the plurality of weight coefficients, updating each of the plurality of weight coefficients included in the neural network such that an objective function obtained by adding a basic loss function and an L2 regularization term multiplied by a regularization strength is minimized;
after executing the first processing:
specifying an inactive node and an inactive channel among a plurality of nodes and a plurality of channels included in the neural network;
deleting the inactive node and the inactive channel from the neural network;
determining whether or not a size of the neural network from which the inactive node and the inactive channel are deleted is a target size or less after the inactive node and the inactive channel are deleted;
completing the first processing and outputting the configuration information of the neural network when the size of the neural network is the target size or less; and
re-executing the first processing when the size of the neural network is not the target size or less,
wherein the method further comprises:
in a first iteration of the first processing,
setting the regularization strength such that the regularization strength increases as a target deletion ratio increases, and
in a second or subsequent iteration of the first processing,
changing the regularization strength to be smaller than the regularization strength in the first iteration.

22. The method according to claim 21,
wherein, for each of the plurality of weight coefficients, in the updating, a gradient is calculated based on the objective function, a step width is calculated based on the gradient and a corresponding past gradient, and the plurality of weight coefficients are updated based on the calculated step width such that the objective function is decreased.

23. The method according to claim 22,
wherein an activation function including an interval of an input value at which a differential function becomes 0 or an interval of an input value at which the differential function is asymptotic to 0 is set in the neural network.

24. The method according to claim 23,
wherein, in the differential function of the activation function, an interval of an input value on a positive side further than a predetermined input value is larger than 0, and an interval of an input value on a negative side further than the predetermined input value is 0 or asymptotic to 0.

25. The method according to claim 23,
wherein activation functions set in all nodes and channels included in all intermediate layers of the neural network are identical to one another.

26. The method according to claim 22,
wherein, in the specifying, a node and a channel for which norms of weight vectors are a predetermined threshold value or less are specified as the inactive node and the inactive channel.

27. The method according to claim 24,
wherein the activation function is ReLU.

28. The method according to claim 24,
wherein the activation function is ELU

29. The method according to claim 23,
wherein the activation function is hyperbolic tangent

30. The method according to claim 22,
wherein, in the updating, the weight coefficient is updated by an algorithm of Adaptive Moment Estimation (Adam).

31. The method according to claim 22,
wherein, in the updating, the weight coefficient is updated by an algorithm of RMSprop.

32. A learning device that optimizes a neural network, comprising:
one or more processors configured to:
acquire configuration information of the neural network;
acquire a plurality of pieces of training information including an input vector and a target vector serving as a target of an output vector;
execute a first processing of repeating executing a forward direction process, generating an error vector, executing a reverse direction process, and updating each of a plurality of weight coefficients a predetermined number of times;
in the forward direction process, assign the input vector to an input layer of the neural network, cause operation data to be propagated in a forward direction, and cause the output vector to be output from an output layer;
in the generating of the error vector, generate the error vector based on the output vector and the target vector;
in the reverse direction process, assign the error vector to the output layer of the neural network and cause error data to be propagated in a reverse direction;
in the updating of each of the plurality of weight coefficients, update each of the plurality of weight coefficients included in the neural network such that an objective function obtained by adding a basic loss function and an L2 regularization term multiplied by a regularization strength is minimized;
after executing the first processing,
specify an inactive node and an inactive channel among a plurality of nodes and a plurality of channels included in the neural network;
delete the inactive node and the inactive channel from the neural network;
determine whether or not a size of the neural network from which the inactive node and the inactive channel are deleted is a target size or less after the inactive node and the inactive channel are deleted;
complete the first processing and output the configuration information of the neural network when the size of the neural network is the target size or less; and
re-execute the first processing when the size of the neural network is not the target size or less,
wherein the one or more processors are further configured to:
in a first iteration of the first processing,
set the regularization strength such that the regularization strength increases as a target deletion ratio increases, and in a second or subsequent iteration of the first processing,
change the regularization strength to be smaller than the regularization strength in the first iteration.

33. The device according to claim 32, wherein
activation functions set in all nodes and channels included in all intermediate layers of the neural network include an interval of an input value at which a differential function becomes 0 or an interval of an input value at which the differential function is asymptotic to 0,
for each of the plurality of weight coefficients, the one or more processors calculates a gradient based on the objective function, calculates a step width based on the gradient and a corresponding past gradient, and updates the plurality of weight coefficients based on the calculated step width such that the objective function is decreased, and
the one or more processors specifies a node and a channel for which norms of weight vectors are a predetermined threshold value or less as the inactive node and the inactive channel.

34. The device according to claim 33,
wherein the activation function is ReLU, and
the one or more processors update the plurality of weight coefficients in accordance with an optimization algorithm of Adaptive Moment Estimation (Adam).
